(19) United States
(12) Patent Application Publication
(10) Pub. No.: US 2022/0236499 A1
(43) Pub. Date: Jul. 28, 2022

(54) INTEGRATED COLOUR FILTER ARRAY AND FIBRE OPTIC PLATE

(71) Applicant: Varjo Technologies Oy, Helsinki (FI)

(72) Inventors: Oiva Arvo Oskari Sahlsten, Salo (FI); Klaus Melakari, Oulu (FI)

(73) Assignee: Varjo Technologies Oy, Helsinki (FI)

(21) Appl. No.: 17/155,416

(22) Filed: Jan. 22, 2021

(51) Int. Cl. G02B 6/42

(52) U.S. Cl. CPC G02B 6/4215

(57) ABSTRACT

An optical device. The optical device includes a fibre optic plate having an input surface and an output surface, the fibre optic plate including a plurality of optical fibres; and a colour filter array including a plurality of colour filters formed on at least one of: the input surface, the output surface of the fibre optic plate.

### TECHNICAL FIELD

The present disclosure relates to optical devices. Furthermore, the present disclosure also relates to display devices. Moreover, the present disclosure also relates to methods of manufacturing optical devices.

### BACKGROUND

In recent past, there have been tremendous advancements in optoelectronics and associated high-end imaging applications. Some of these specialized imaging applications require collimated light to emanate from display devices (such as displays of smartphones, displays of extended-reality devices, and the like). Presently, fibre optic plates (FDPs) including multiple optical fibres have attracted global attention and widespread use with regards to their excellent optical conductivity and light collimation properties.

Typically, an FOP is arranged on top of an image displaying surface of a display devices and is used for collimating light emanating from the image displaying surface of the display device, directing the light to a required direction, or magnifying an image displayed on the display device. A challenge with FOP integration with display devices is that if entry of light into the FOP has any light scattering, the FOP will act as an optical diffuser and therefore contrast and resolution of displayed visual content (such as images, videos, and the like) on the display device are compromised.

Conventionally, the FOP integration with display devices has been achieved by gluing the FOP to a top surface (i.e. an outermost surface) of a cover glass of the display device using an optically clear adhesive or an optical index matching glue. Typically, resolution of the display devices has been low compared to thickness of the cover glass and in these cases the reduction of contrast and resolution has been acceptable. This seems to be acceptable when the thickness of the cover glass is of the order of less than ten times of a size of a pixel of the display device. However, new display technologies are quite advanced and have very high resolutions such that there is easily 20 times or even 100 times ratio between the size of the pixel and the thickness of the cover glass. This creates a challenge for the FOP integration as in such cases, the FOP practically starts to diffuse or blur the displayed visual content. As a result, the contrast and resolution reduce to unacceptable levels, and adversely impact viewing experiences of the display device.

Therefore, in light of the foregoing discussion, there exists a need to overcome the aforementioned drawbacks with conventional manners of integrating fibre optic plates with display devices.

### SUMMARY

The present disclosure seeks to provide an optical device. The present disclosure also seeks to provide display device. The present disclosure also seeks to provide a method for manufacturing an optical device. An aim of the present disclosure is to provide a solution that overcomes at least partially the problems encountered in prior art.

In one aspect, an embodiment of the present disclosure provides an optical device comprising:
a fibre optic plate having an input surface and an output surface, the fibre optic plate comprising a plurality of optical fibres; and
a colour filter array comprising a plurality of colour filters formed on at least one of: the input surface, the output surface of the fibre optic plate.

In another aspect, an embodiment of the present disclosure provides a display device comprising:
a fibre optic plate having an input surface and an output surface, the fibre optic plate comprising a plurality of optical fibres;
a colour filter array comprising a plurality of colour filters formed on at least one of: the input surface, the output surface of the fibre optic plate; and
a light emitting unit disposed on the colour filter array, the light emitting unit comprising a plurality of sub-pixels arranged in alignment with respective colour filters.

In yet another aspect, an embodiment of the present disclosure provides a method of manufacturing an optical device, the method comprising forming a plurality of colour filters on at least one of: an input surface, an output surface of a fibre optic plate, the fibre optic plate comprising a plurality of optical fibres.

Embodiments of the present disclosure substantially eliminate or at least partially address the aforementioned problems in the prior art, and enable robust integration of the fibre optic plate with the colour filter array in a manner that the fibre optic plate effectively collimates light passing through the colour filter array and ensures best possible (i.e. high) contrast and resolution.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a cross-section of an optical device, in accordance with an embodiment of the present disclosure;

FIG. 2 is a cross section of a display device, in accordance with an embodiment of the present disclosure;

FIG. 3 is a schematic illustration of a sub-pixel structure in a light emitting unit, in accordance with an embodiment of the present disclosure;

FIG. 4 is an illustration of a pattern of colour filters in a colour filter array, in accordance with an embodiment of the present disclosure;

FIGS. 5A and 5B are schematic illustrations of exemplary implementations of an optical device, in accordance with different embodiments of the present disclosure; and

FIG. 6 is a flowchart illustrating steps of a method of manufacturing an optical device, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides an optical device comprising:
a fibre optic plate having an input surface and an output surface, the fibre optic plate comprising a plurality of optical fibres; and
a colour filter array comprising a plurality of colour filters formed on at least one of: the input surface, the output surface of the fibre optic plate.

In another aspect, an embodiment of the present disclosure provides a display device comprising:
a fibre optic plate having an input surface and an output surface, the fibre optic plate comprising a plurality of optical fibres;
a colour filter array comprising a plurality of colour filters formed on at least one of: the input surface, the output surface of the fibre optic plate; and
a light emitting unit disposed on the colour filter array, the light emitting unit comprising a plurality of sub-pixels arranged in alignment with respective colour filters.

In yet another aspect, an embodiment of the present disclosure provides a method of manufacturing an optical device, the method comprising forming a plurality of colour filters on at least one of: an input surface, an output surface of a fibre optic plate, the fibre optic plate comprising a plurality of optical fibres.

The present disclosure provides the aforesaid optical device, the aforesaid display device, and the aforesaid method of manufacturing the optical device. The optical device enables effective collimation of light passing from the colour filter array towards the fibre optic plate, and ensures provision of best possible contrast and resolution of visual content constituted by the light. The robust design of the optical device, and the fibre optic plate integration with the colour filter array makes the optical device compact and convenient to handle. This integration ensures that no light scattering occurs in the optical device. Moreover, the integrated design of the optical device enables use thereof in a wide variety of optoelectronic applications. Notably, said integration of the fibre optic plate and the colour filter array enables excellent readability and contrast of displays even with extremely small pixel sizes. Therefore, it is possible to use the aforesaid optical device collimation and colour filtering arrangement even in display devices of micro-nano scales. The display device described herein is easy to manufacture, and incorporates the optical device effectively to provide high resolution and contrast of visual content. The method described herein is easy to implement.

Throughout the present disclosure, the term “optical device” as used herein refers to a device controlling an optical path of light. Notably, the optical device is employed to enhance visual quality of an image that is displayed by the display device employing the optical device. The visual quality of the image may be expressed in terms of its contrast and/or resolution, or similar. An edge response test can be used to measure image transmission through the optical device. The fibre optic plate of the optical device acts as a light collimator, while the colour filter array acts as a light filter that selectively passes lights of specific wavelengths or wavelength ranges through individual colour filters of the array.

Throughout the present disclosure, the term “fibre optic plate” as used herein refers to an optical element comprising plurality of micron-sized or nano-sized optical fibres that collectively form a unified structure. The axes of the plurality of optical fibres are perpendicular to an image displaying surface, wherein the input surface of the fibre optic plate is adjacent to the image displaying surface, and the output surface is opposite to the input surface. The plurality of optical fibres are transparent thin fibres, usually made of glass or plastic, and are used for guiding (namely, transmitting) light. The plurality of optical fibres serve as light collimators and transmit light emanating from the image displaying surface as a substantially parallel beam. The fibre optic plate has minimal thickness (for example, less than one inch) and is capable of effectively transmitting light from the input surface to the output surface with a minimum loss or spillage of light. A clear aperture of the fibre optic plate can be maximized by a wise selection of cladding material and optionally, of masking material. It will be appreciated that the plurality of optical fibres of the fibre optic plate may be fused together (under high pressure and temperature) or may be aligned together with only the ends being rigidly fastened together, to form the fibre optic plate. The fibre optic plate may also be commonly referred to as a “fibre optic faceplate”.

Optionally, a given surface of the fibre optic plate is fabricated in a given shape. The given shape may be selected from amongst a variety of shapes, such as a square, a rectangle, a circle, a polygon, a cone, a trapezium, or other aspheric configurations, for example. The given shape of the given surface may correspond to a shape of the colour filter array, for proper integration therebetween. Optionally, the fibre optic plate may be obtained from a fibre optic block (namely, boule) of precisely aligned optical fibres that are stacked and fused together, by sectioning the fibre optic block at a required angle. This required angle may, for example, be 10 degrees, 30 degrees, 45 degrees, 60 degrees, 90 degrees, and so forth.

Optionally, the plurality of the optical fibres in the fibre optic plate range in diameter from 1 to 100 microns. It will be appreciated that other values of diameters and lengths of the plurality of optical fibres lying outside the aforesaid ranges are also feasible. Optionally, the fibre optic block may for example have a length in a range of 1 to 70 inches, a width in a range of 1 to 70 inches and a height in a range of 1 to 100 inches. In such an example, the length of the fibre optic block may be from 1, 2, 3, 4, 5, 10, 15, 20, 30, 40, 50 or 60 inches up to 2, 3, 4, 5, 10, 15, 20, 30, 40, 50, 60 or 70 inches, the width of the fibre optic block may be from 1, 2, 3, 4, 5, 10, 15, 20, 30, 40, 50 or 60 inches up to 2, 3, 4, 5, 10, 15, 20, 30, 40, 50, 60 or 70 inches, and the height of the fibre optic block may be from 1, 2, 3, 4, 5, 10, 15, 20, 30, 40, 50, 60, 70, 80 or 90 inches up to 4, 5, 10, 15, 20, 30, 40, 50, 60, 70, 80, 90 or 100 inches. It will be appreciated that other values of diameters, lengths, widths, and heights of the fibre optic block lying outside the aforesaid ranges are also feasible. In that case, the length of finalised fibre optic plate can be almost anything as typically these are manufactured in longer “rods” or “blocks” that are then cut and polished for the needed fibre optic plate thickness or length.

Optionally, the fibre optic block is cut to obtain requisite dimensions of the fibre optic plate. Optionally, a given surface of the fibre optic plate is planar, curved, freeform, or a combination of these. Therefore, the input surface-output surface of the fibre optic plate may be plano-piano, plano-concave, plano-convex, plano-aspheric, plano-freeform, convex-concave, or similar.

Optionally, the output surface of the fibre optic plate is curved. In such a case, a focal plane or a wave front of light that exits the fibre optic plate can be modified using uneven lengths of optical fibres in the fibre optic plate. The uneven length of optical fibres generate curved surfaces and curved focal planes of the fibre optic plate. In an embodiment, the output surface of the fibre optic plate is concave. Optionally, in this regard, the input surface is planar. In such a case, the fibre optic plate is plano-concave. In such case, the length of the plurality of optical fibres typically increases on going from a middle portion of the fibre optic plate towards an end of the fibre optic plate. In another embodiment, the output surface of the fibre optic plate is convex. Optionally, in this regard, the input surface is planar. In such a case, the fibre optic plate is plano-convex. In such a case, the length of the plurality of optical fibres decreases on going from a middle portion of the fibre optic plate towards an end of the fibre optic plate. In yet another embodiment, the output surface of the fibre optic plate is aspheric. Notably, the aspheric surface allows variable angular resolution (VAR) images to be projected to the user. Such VAR images have at least two portions having at least two different resolutions. Beneficially, the curved shape of the output surface of the fibre optic plate allows for some useful optical implementations enabling, for example, minimizing distortion within a field of view of an image. Additionally, display canting or other repositioning could become easier if uneven length of optical fibres is used in the fibre optic plate. Using uneven lengths of optical fibres may lead to a more favorable mechanical integration of the fibre optic plate with other components, as well as an improvement in optical performance of the fibre optic plate.

Optionally, a size of the fibre optic plate ranges from 0.05 to 50.0 inch in length or from 0.5 to 20.0 inch in diameter. The size of fibre optic plate may for example range from 0.05, 0.1, 0.5, 1.0, 2.0, 3.0, 4.0, 5.0, 10.0, 20.0, 30.0 or 40.0 inch up to 0.1, 0.5, 1.0, 2.0, 3.0, 4.0, 5.0, 10.0, 20.0, 30.0, 40.0 or 50.0 inch in length or from 0.5, 0.1, 0.5, 1.0, 2.0, 3.0, 4.0, 5.0, 10.0 or 15.0 inch up to 0.1, 0.5, 1.0, 2.0, 3.0, 4.0, 5.0, 10.0, 15.0 or 20.0 inch in diameter. For example, the fibre optic plate sliced from the fibre optic block may for example be a cuboid having a length of 4 inches, a width of 3 inches and a height 0.1 inches. In an example, fibre optic plate having length shorter than 2000 micron might be usable. Notably, only few hundred microns may be minimum requirement to gain collimation. In another example, finalized fibre optic plate can be even several centimetres long, as there can be very small light losses in the material. However, then the fibre optic plate will get very heavy as well as very expensive as the rod can be cut to only few finalised fibre optic plates. Typically, fibre optic plate has a diameter in a range of 0.5 to 4.0 inch, optionally up to 1 inch. Notably, fibre optic plates with large diameters are used as special products. Moreover, total quantity of fibres in the fibre optic plate is based on the individual optical fibre size and cladding material thickness. It will be appreciated that the fibre optic block is prepared by any method known in the art, such as for example chemical vapor deposition. It will be appreciated that the input surface and/or the output surface of the fibre optic plate may need to be further processed using manufacturing techniques such as grinding, polishing and the like, before integrating the fibre optic plate with the colour filter array. This further processing may be required to manufacture the fibre optic plate to be similar to a typical substrate that is used for colour filter arrays. In addition, the polished and/or ground surface(s) of the fibre optic plate may be shaped and/or optically coated if required.

Optionally, the fibre optic plate is fabricated in a variety of sizes, shapes and modifications based on the application thereof. Optionally, the fibre optic plate are fabricated with extramural absorption glass, an opaque second cladding (i.e. an extramural absorption cladding) designed to eliminate unconducted light, and the like, based on an end use application thereof, such as for example, extended-reality applications requiring maintaining high contrast and resolution for providing immersive visual experiences to users. In this regard, the amount of such cladding may be varied to conform with fibre optic plate thickness and contrast requirements for the end use applications. Moreover, glass types such as A-10 glass, H-64 glass, K2 glass, D-11/D-15 glass, D-14 glass, and the like, may be used for manufacturing the fibre optic plate.

Throughout the present disclosure, the term “colour filter array” as used herein refers to an array of the plurality of colour filters (namely, a colour filter mosaic). The colour filter array overlays sub-pixels of the display device. The term “colour filter” refers to an optical element (implemented, for example, as a sheet of transparent material) that selectively passes through itself certain wavelengths of light emanating from a corresponding sub-pixel. Other wavelengths of light that are not passed through the colour filter may be absorbed or reflected by the colour filter. Optionally, the colour filters are typically made from sheets of coloured or dyed glass, plastic, gelatin, and the like, optionally with modifications (such as for example one or more metallic or other type of films of controlled thickness) deposited thereon.

Optionally, the plurality of colour filters comprise at least three types of colour filters that selectively transmit light of at least three different wavelengths. The at least three types of colour filters are selected from a group including a red colour filter, a green colour filter, a blue colour filter, a yellow colour filter, a white colour filter, a cyan colour filter, a magenta colour filter, an emerald colour filter, and so on. Optionally, the colour filter array is a Red-Green-Blue (RGB) colour filter array,
wherein red, green and blue filters selectively pass red, green and blue lights with wavelengths ranging between 580 nm to 750 nm, 490 nm to 580 nm and 400 nm to 490 nm, respectively.

It will be appreciated that the plurality colour filters may be arranged in any requisite pattern in the colour filter array. Optionally, the pattern of the plurality colour filters in the colour filter array corresponds to a sub-pixel pattern of the display device. In an example, the colour filter array comprises a plurality of RGB filters (namely, Bayer filter), wherein each RGB filter includes one blue colour filter, one red colour filter and two green colour filters. In another example, the aforesaid Bayer filters may be modified to have one green colour filter modified to “emerald” colour filter to result in RGBE filters. In another example, the aforesaid Bayer filters may be modified to have one green colour filter modified to “white” or transparent filter to result in a RGBW filter. The transparent filter is optionally a neutral colour filter that transmits all wavelengths. Optionally, a demosaicing algorithm is used, by a processor of the display device incorporating the optical device, to process information pertaining to spectral characteristics of each colour filter of the colour filter array, and adjust an intensity of light at each sub-pixel for displaying a requisite image.

Moreover, the plurality of colour filters are formed on at least one of: the input surface, the output surface of the fibre optic plate. In other words, the colour filter array can be arranged or integrated with the fibre optic plate on either surface or on both surfaces of the fibre optic plate. The fibre optic plate serves as a substrate for the plurality of colour filters. It will be appreciated that fibre optic plate surface(s), i.e. the input surface and/or the output surface, is/are optionally polished to make it suitable for the plurality of colour filters to be well-integrated with the the fibre optic plate surface(s).

In an embodiment, a number of optical fibres in the fibre optic plate lies within a predefined threshold number from a number of colour filters in the colour filter array. The number of optical fibres in the fibre optic plate nearly corresponds or exactly corresponds to the number of colour filters in the colour filter array. The term “predefined threshold number” as used herein refers to a maximum permissible difference between the number of optical fibres in the fibre optic plate the number of colour filters in the colour filter array. The predefined threshold number may be expressed as a percentage of the number of colour filters in the colour filter array. Optionally, the number of optical fibres in the fibre optic plate may be at least 80 percent of the number of colour filters in the colour filter array. In other words, the number of optical fibres may lie in a range of 80 percent to 100 percent of the number of colour filters. The predefined threshold number of the optical fibres in the fibre optic plate may be for example from 80, 85, 90 or 95 percent up to 85, 90, 95 or 100 percent of the number of colour filters in the colour filter array. In an example, the number of optical fibres in the fibre optic plate is 90 percent of the number of colour filters in the colour filter array. In another example, the number of optical fibres in the fibre optic plate is equal to the number of colour filters in the colour filter array.

Optionally, a given colour filter is arranged in alignment with a corresponding optical fibre of the fibre optic plate. In such case, the number of colour filters are equal or nearly equal to the number of optical fibres of the fibre optic plate, and each colour filter is aligned with its corresponding optical fibre. Here, the term “alignment” refers to an arrangement of a colour filter with a corresponding optical fibre in a manner that light passing through the colour filter enters the optical fibre with minimal loss. As noted earlier, the colour filter array may be formed on either surface or on both the surfaces of the fibre optic plate. Therefore, in an example where the colour filter array is formed on the input surface of the fibre optic plate, an input end of each of the optical fibres is in aligned (for example, be in contact with) with a corresponding colour filter. In a simplified example, the optical device may comprise 24 colour filters corresponding to 24 optical fibres of the fibre optic plate. In such example, optical fibres positioned as first, second, third, fourth, fifth, sixth optical fibres, and so on, may be integrally arranged in alignment with colour filters of red, green, blue, red, green, blue, and so on, respectively, thereby resulting in a RGB colour filter array integration with the fibre optic plate.

It will be appreciated that the number of optical fibres and the number of colour filters are set at a time of manufacturing the optical device. Moreover, the number of optical fibres and the number of colour filters could also be set at a time of manufacturing the display device, based on a pixel size or a sub-pixels size of the display device.

In some cases, a given colour filter may not be perfectly arranged in alignment with a corresponding optical fibre of the fibre optic plate. In other words, the given colour filter may be arranged at an offset with the corresponding optical fibre. In such a case, some light leaks from one optical fibre to another. However, since the human eyes' sensitivity to colour resolution is less than sensitivity to brightness resolution, an actual perceived sharpness of the image (displayed at the display device incorporating the optical device) is not much impacted, as long as the number of the optical fibres are roughly (namely, nearly) the same as the number of sub-pixels of the display device.

In another embodiment, the plurality of colour filters comprise a plurality of groups of colour filters, wherein a given group of colour filters is associated with sub-pixels of a given pixel and is arranged in alignment with a corresponding optical fibre of the fibre optic plate. The term “sub-pixel” as used herein refers to a separately addressable single-colour picture element. The plurality of sub-pixels of the given pixel are arranged in a required form (for example, such as a one-dimensional array, a two-dimensional grid, a PenTile® matrix layout, a hexagonal layout, a circular layout, and the like). It will be appreciated that dividing pixels into sub-pixels results in increasing an apparent resolution of the displayed image. As pixel size (and correspondingly, sub-pixel size) is reduced to increase resolution of the display device, maintaining a requisite spatial gap or spacing between individual optical fibres of the fibre optic plate becomes difficult. Oversampling pixels in the aforesaid manner, by dividing the pixels into smaller sub-pixels having sizes much smaller as compared to individual optical fibres, enables use of one optical fibre for multiple sub-pixels of one pixel in a manner that requisite spatial gap or spacing between individual optical fibres of the fibre optic plate can be easily maintained. With this implementation of the optical device, readability and contrast achieved for display devices having small pixel sizes is quite high.

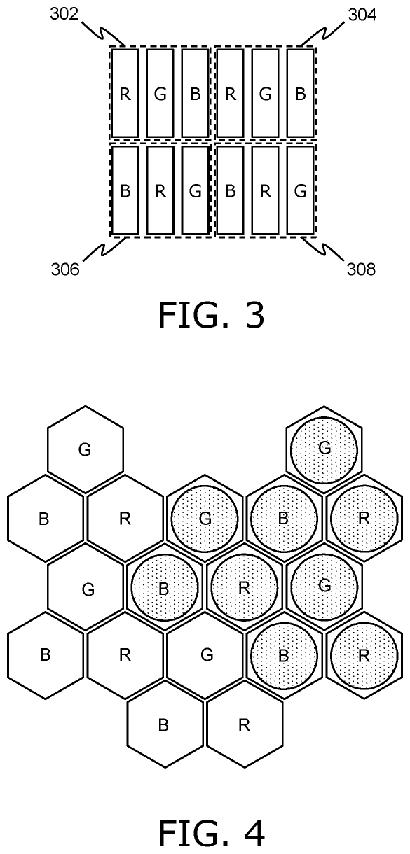

Optionally, the given pixel comprises 3 sub-pixels. As an example, the given pixel may comprise a red sub-pixel, a green sub-pixel, and a blue sub-pixel. Four such exemplary pixels have been illustrated in conjunction with FIG. 3, as described below. Alternatively, optionally, the given pixel comprises 5 sub-pixels. Optionally, in this regard, the 5 sub-pixels comprise two red sub-pixels, two green sub-pixels, and one blue sub-pixel that are arranged in the PenTile® matrix layout. Optionally, the given pixel may comprise a reduced set of sub-pixels. As an example, instead of an entire set of red, green, and blue sub-pixels, the given pixel may comprise a reduced set of only red and green sub-pixels. It will be appreciated that the given pixel may comprise any number of sub-pixels as commonly used in the art.

In an example, the optical device eight may comprise eight groups of colour filters, wherein each group of colour filters comprises 3 colour filters, such as an RGB filter. In such case, one group of RGB colour filters corresponds to RGB sub-pixels of one pixel. Additionally, each group of RGB colour filter corresponding to one pixel of RGB sub-pixels may be arranged in alignment with one optical fibre of the fibre optic plate. Therefore, the aforesaid eight groups of colour filters are aligned with eight optical fibres of the fibre optic plate.

Optionally, a plurality of fiducial markers are formed on the fibre optic plate. The term “fiducial markers” as used herein refer to guiding elements that enable locating with greater accuracy a desired site for forming the plurality of colour filters on a given surface of the fibre optic plate. Typically, the fiducial markers serve as reference points or a measure for precisely arranging in alignment the plurality of colour filters corresponding to the plurality of optical fibres of the fibre optic plate. With these fiducial markers, the fibre optic plate can also be aligned precisely with sub-pixels of the display device. Beneficially, forming the plurality of fiducial markers and using the plurality of fiducial markers for forming the plurality of colour filters on any surface (and specially, on the output surface) of the fibre optic plate eases the alignment dilemma during arrangement of the fibre optic plate and the colour filter array. Additionally, beneficially, such fiducial markers also open an opportunity to use much simpler manufacturing processes for forming the plurality of colour filters (when manufacturing the optical device) such as printing technologies.

Optionally, the plurality of colour filters are printed on the at least one of: the input surface, the output surface of the fibre optic plate. Optionally, in this regard, the plurality of colour filters may be printed using a 3D printing technique, an additive manufacturing technique, a photolithography technique and the like. It will be appreciated that the techniques for printing the plurality of colour filters on a given surface of the fibre optic plate are well known in the art.

In an exemplary implementation, the aforesaid optical device comprising the aforesaid fibre optic plate integrated with the aforesaid colour filter array, transmits light through itself by repeated internal reflections within the fibre optic plate. Beneficially, the optical device provides high resolution, minimal distortion, and minimal thickness passage for transfer of light therethrough and may be used in different display devices to enable image intensification, immersive viewing, image field of view flattening, and the like.

The present disclosure also relates to the display device as described above. Various embodiments and variants disclosed above apply mutatis mutandis to the display device.

Throughout the present disclosure, the term “display device” as used herein refers to specialized equipment that is configured to display images when the display device is in operation. The display device may be used in devices such as smartphones, tablet computers, laptop computers, desktop computers, extended reality (XR) headsets, XR glasses, televisions, and the like, that are operable to present the images to users. Herein, the term “extended-reality” encompasses virtual reality (VR), augmented reality (AR), mixed reality (MR), and the like.

It will be appreciated that the display device could be a multi-resolution display device or a single-resolution display device. Multi-resolution display devices are configured to display images at two or more resolutions, whereas single-resolution display devices are configured to display images at a single resolution only. Herein, the “resolution” of the display device refers to a total number of pixels in each dimension of the display device, or to a pixel density (namely, a number of pixels per unit distance or area) in the display device.

Optionally, display device is implemented as a display. Examples of the display include, but are not limited to, a Liquid Crystal Display (LCD), a Light-Emitting Diode (LED)-based display, an Organic LED (OLED)-based display, a micro OLED-based display, an Active Matrix OLED (AMOLED)-based display, and a Liquid Crystal on Silicon (LCoS)-based display. As an example, the display device may be a micro OLED-based display.

Optionally, the display device has a multi-layered structure. In this regard, the multi-layered structure comprises layers such as, but not limited to, a layer comprising a plurality of sub-pixels, a layer comprising the colour filter array, a layer comprising the fibre optic plate, encapsulation glass, backplanes built on substrates (for example, such as glass, polyimide, and so forth), protection films (for example, such as an outermost protective layer that is transparent to visible light), optical diffusers, and top and/or bottom polarizers. Optionally, an image displaying surface of the display device is an outermost front layer (namely, a front surface) of the multi-layered structure from which projections of the displayed images emanate.

The term “light emitting unit” as used herein refers to an element of the display device that, in operation, emits light. Optionally, the light emitting unit is implemented as one or more layers of the display device from which light is emitted. The light emitting unit emits light in any possible manner, wherein a colour of a given sub-pixel of the light emitting unit is given by a colour filter corresponding to the given sub-pixel. The light emitting unit may comprise a plurality of liquid crystals with backlights, a plurality of LEDs, a plurality of OLEDs, and the like. Such light emitting units are well-known in the art.

The plurality of sub-pixels of the light emitting unit are arranged in alignment with their respective colour filters. A colour of a given sub-pixel of the light emitting unit is given by a colour filter corresponding to the given sub-pixel. The colour filter selectively filters light emitted by the given sub-pixel. The plurality of sub-pixels constitute a plurality of pixels of the light emitting unit, wherein the plurality of pixels are arranged in a required manner (for example, such as a rectangular two-dimensional grid). A given pixel of the light emitting unit comprises a plurality of sub-pixels. A given sub-pixel is a separately addressable single-colour picture element. The plurality of sub-pixels of the given pixel are arranged in a required form (for example, such as a one-dimensional array, a two-dimensional grid, a PenTile® matrix layout, and the like). Optionally, the given pixel comprises 3 sub-pixels. As an example, the given pixel may comprise a red sub-pixel, a green sub-pixel, and a blue sub-pixel. These 3 sub-pixels are arranged in alignment with their respective colour filters. As another example, the given pixel may comprise a cyan sub-pixel, a magenta sub-pixel, and a yellow sub-pixel. Alternatively, optionally, the given pixel comprises 5 sub-pixels. Optionally, in this regard, the 5 sub-pixels comprise two red sub-pixels, two green sub-pixels, and one blue sub-pixel that are arranged in the PenTile® matrix layout. Optionally, the given pixel may comprise a reduced set of sub-pixels. As an example, instead of an entire set of red, green, and blue sub-pixels, the given pixel may comprise a reduced set of only red and green sub-pixels.

Moreover, the plurality of sub-pixels of the light emitting unit are arranged in alignment with the respective colour filters. Optionally, the number of colour filters in the colour filter array is equal to the number of sub-pixels of the light emitting device, and each colour filter is aligned with a corresponding sub-pixel of the light emitting unit. Here, the term “alignment” refers to a requisite arrangement of a colour filter with a corresponding sub-pixel of the light emitting unit, in a manner that light emitted by the sub-pixel is filtered by the colour filter. As noted earlier, the colour filter array is formed on either surface or both the surfaces of the fibre optic plate. Therefore, in an example where the colour filter array is formed on the input surface of the fibre optic plate, the colour filter is in contact with a corresponding sub-pixel of the light emitting unit. In an example, the optical device may comprise 24 colour filters corresponding to 24 sub-pixels of the light emitting unit. In such example, sub-pixels of the light emitting unit positioned as first sub-pixel, second sub-pixel, third sub-pixel, fourth sub-pixel, fifth sub-pixel, sixth sub-pixel, and so on may be arranged in alignment with a corresponding colour filters of red, green, blue, red, green, blue, and so on respectively.

Optionally, the plurality of colour filters are formed according to a sub-pixel pattern of the display device. A pattern of forming the plurality of colour filters corresponds to the sub-pixel pattern in a manner that a given colour filter is accurately formed over and is well-aligned with its corresponding sub-pixel. A pattern of the plurality of colour filters corresponds to the sub-pixel pattern of the display device. Examples of the sub-pixel pattern and the pattern of the plurality of colour filters include, but are not limited to, a striped pattern, an alternated stripes pattern, a checkered pattern, a hexagonal tiled pattern, a grid pattern, and a PenTile pattern.

Optionally, a number of optical fibres in the fibre optic plate lies within a predefined threshold number from a number of colour filters in the colour filter array.

Optionally, a given colour filter is arranged in alignment with a corresponding optical fibre of the fibre optic plate.

Optionally, the plurality of colour filters comprise a plurality of groups of colour filters, wherein a given group of colour filters is associated with sub-pixels of a given pixel and is arranged in alignment with a corresponding optical fibre of the fibre optic plate.

Optionally, the plurality of colour filters are printed on the at least one of: the input surface, the output surface of the fibre optic plate.

Optionally, the output surface of the fibre optic plate is curved.

The present disclosure also relates to the method as described above. Various embodiments and variants disclosed above apply mutatis mutandis to the method.

The method of manufacturing the optical device encompasses all possible steps pertaining to manufacturing and integration of the colour filter array with the fibre optic plate. The forming of the plurality of colour filters on at least one of: the input surface, the output surface of the fibre optic plate may be achieved using conventional techniques of manufacturing the fibre optic plate and the plurality of colour filters and assembling the plurality of colour filters and the fibre optic plate in a required manner. Manufacturing of fibre optic plates and colour filters is well-known in the art. In an example, forming plurality of colour filters on at least one of: the input surface, the output surface of the fibre optic plate is achieved using 3D printing technology. In one example, the number of colour filters of the colour filter array may be formed to be equal to and may be arranged in alignment with a corresponding number of optical fibres of the fibre optic plate. In another example, the number of colour filters of the colour filter array may be greater than the number of optical fibres of the fibre optic plate and multiple colour filters may be arranged in alignment with a corresponding optical fibre of the fibre optic plate.

Optionally, a given colour filter is formed in alignment with a corresponding optical fibre of the fibre optic plate.

Optionally, the plurality of colour filters comprise a plurality of groups of colour filters, wherein a given group of colour filters is associated with sub-pixels of a given pixel and is formed in alignment with a corresponding optical fibre of the fibre optic plate.

Optionally, the method further comprises forming a plurality of fiducial markers on the fibre optic plate, wherein the step of forming the plurality of colour filters is performed using the plurality of fiducial markers. The fiducial markers are typically formed on the fibre optic plate using conventional techniques known in the art, including but not limited to, printing techniques, fiducial marker placement techniques, soldering techniques, engraving techniques, and the like.

Optionally, the step of forming the plurality of colour filters comprises printing the plurality of colour filters on the at least one of: the input surface, the output surface of the fibre optic plate. The techniques for printing the plurality of colour filters are well-known in the art.

Optionally, the method further comprises polishing the at least one of: the input surface, the output surface of the fibre optic plate prior to forming the plurality of colour filters. A given surface of the fibre optic plate may be polished either manually, mechanically, or by a combination of these. Polishing the given surface of the fibre optic plate may be performed using one or more polishing tools and/or polishing materials such as polishing pads, polishing plates, polishing films, polishing cleaners, and the like.

### DETAILED DESCRIPTION OF THE DRAWINGS

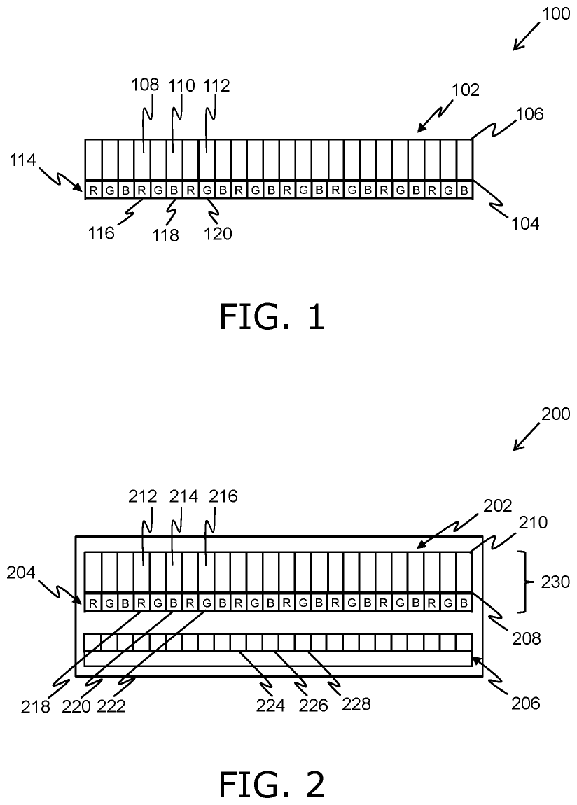

Referring to FIG. 1, illustrated is a cross-section of an optical device 100, in accordance with an embodiment of the present disclosure. As shown, the optical device 100 comprises a fibre optic plate 102 having an input surface 104 and an output surface 106. The fibre optic plate 102 comprises a plurality of optical fibres, such as optical fibres 108, 110 and 112. Both the input surface 104 and the output surface 106 of the fibre optic plate are shown to be planar in shape. Moreover, the optical device 100 comprises a colour filter array 114 comprising a plurality of colour filters, such as colour filters 116, 118 and 120, formed on at least one of: the input surface 104, the output surface 106 of the fibre optic plate 102. For sake of simplicity, the plurality of colour filters are shown to be formed on the input surface 104. The plurality of colour filters include red colour filters depicted as ‘R’, green colour filters depicted as ‘G’, and blue colour filters depicted as ‘B’. In the optical device 100, a given colour filter is arranged in alignment with a corresponding optical fibre of the fibre optic plate 102. This is depicted, for example, as the colour filters 116, 118, and 120 being arranged in alignment with the optical fibres 108, 110, and 112, respectively.

It may be understood by a person skilled in the art that the FIG. 1 is merely an example for sake of clarity, which should not unduly limit the scope of the claims herein. The person skilled in the art will recognize many variations, alternatives, and modifications of embodiments of the present disclosure.

Referring to FIG. 2, illustrated is a cross-section of a display device 200, in accordance with an embodiment of the present disclosure. The display device 200 comprises a fibre optic plate 202, a colour filter array 204, a light emitting unit 206 disposed on the colour filter array 204. The fibre optic plate 202 has an input surface 208 and an output surface 210. The fibre optic plate 202 comprises a plurality of optical fibres, such as optical fibres 212, 214, and 216. The colour filter array 204 comprises a plurality of colour filters (such as colour filters 218, 220, and 222) formed on at least one of: the input surface 208, the output surface 210 of the fibre optic plate 202. The plurality of colour filters include red colour filters depicted as ‘R’, green colour filters depicted as ‘G’, and blue colour filters depicted as ‘B’. The light emitting unit 206 is disposed on the colour filter array 204. Moreover, the light emitting unit 206 comprises a plurality of sub-pixels, such as sub-pixels 224, 226 and 228, arranged in alignment with respective colour filters. The fibre optic plate 202 and the colour filter array 204 are integrated to form an optical device 230.

Referring to FIG. 3, illustrated is a sub-pixel structure in a light emitting unit, in accordance with an embodiment of the present disclosure. As shown, four pixels 302, 304, 306, and 308 of the light emitting unit are arranged as a 2*2 grid. Each of the four pixels 302, 304, 306, and 308 includes 3 sub-pixels (notably, a red sub-pixel is depicted as ‘R’, a green sub-pixel is depicted as ‘G’, and a blue sub-pixel is depicted as ‘B’).

Referring to FIG. 4, illustrated is a pattern of colour filters in a colour filter array, in accordance with an embodiment of the present disclosure. The colour filters include red colour filters depicted as ‘R’, green colour filters depicted as ‘G’, and blue colour filters depicted as ‘B’, arranged in a hexagonal tiled pattern. The colour filters may be formed according to a sub-pixel pattern of a display device (not shown). The colour filters are aligned with optical fibres (depicted as hatched circles on top of some colour filters) of a fibre optic plate (not shown).

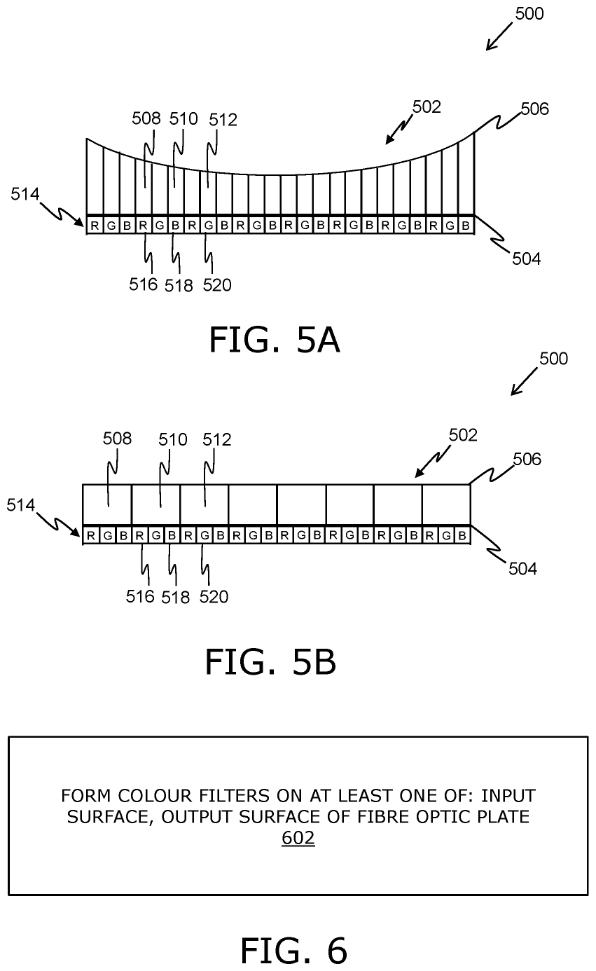

Referring to FIGS. 5A and 5B, illustrated are exemplary implementations of an optical device 500, in accordance with different embodiments of the present disclosure. As shown, the optical device 500 comprises a fibre optic plate 502 having an input surface 504 and an output surface 506. The fibre optic plate 502 comprises a plurality of optical fibres, such as optical fibres 508, 510 and 512. Moreover, the optical device 500 comprises a colour filter array 514 comprising a plurality of colour filters, such as colour filters 516, 518 and 520, formed on the input surface 504 of the fibre optic plate 502. The colour filters include red colour filters depicted as ‘R’, green colour filters depicted as ‘G’, and blue colour filters depicted as ‘B’.

In FIG. 5A, the fibre optic plate 502 is shown to have a plano-concave surface with the input surface 504 having a planar shape and the output surface 506 having a concave shape. The output surface 506 is curved. Furthermore, one colour filter is shown to be arranged in alignment with one corresponding optical fibre of the fibre optic plate 502.

In FIG. 5B, the fibre optic plate 502 is shown to have a plano-piano surface with both the input surface 504 and the output surface 506 having a planar shape. The plurality of colour filters includes eight groups of colour filters, wherein each group of colour filters includes, for example, one red colour filter, one green colour filter, and one blue colour filter. Furthermore, each group of these three colour filters (that are associated with sub-pixels of a given pixel (not shown)) is shown to be arranged in alignment with one corresponding optical fibre of the fibre optic plate 502.

Referring to FIG. 6, there is shown a flowchart illustrating steps of a method of manufacturing an optical device, in accordance with an embodiment of the present disclosure. At step 602, a plurality of colour filters are formed on at least one of: an input surface, an output surface of a fibre optic plate, the fibre optic plate comprising a plurality of optical fibres.

The step 602 is only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. An optical device comprising:
a fibre optic plate having an input surface and an output surface, the fibre optic plate comprising a plurality of optical fibres; and
a colour filter array comprising a plurality of colour filters formed on at least one of: the input surface, the output surface of the fibre optic plate.

2. The optical device of claim 1, wherein a number of optical fibres in the fibre optic plate lies within a predefined threshold number from a number of colour filters in the colour filter array.

3. The optical device of claim 2, wherein a given colour filter is arranged in alignment with a corresponding optical fibre of the fibre optic plate.

4. The optical device of claim 1, wherein the plurality of colour filters comprise a plurality of groups of colour filters, wherein a given group of colour filters is associated with sub-pixels of a given pixel and is arranged in alignment with a corresponding optical fibre of the fibre optic plate.

5. The optical device of claim 1, wherein the plurality of colour filters are printed on the at least one of: the input surface, the output surface of the fibre optic plate.

6. The optical device of claim 1, wherein the output surface of the fibre optic plate is curved.

7. A display device comprising:
a fibre optic plate having an input surface and an output surface, the fibre optic plate comprising a plurality of optical fibres;
a colour filter array comprising a plurality of colour filters formed on at least one of: the input surface, the output surface of the fibre optic plate; and
a light emitting disposed on the colour filter array, the light emitting unit comprising a plurality of sub-pixels arranged in alignment with respective colour filters.

8. The display device of claim 7, wherein a number of optical fibres in the fibre optic plate lies within a predefined threshold number from a number of colour filters in the colour filter array.

9. The display device of claim 8, wherein a given colour filter is arranged in alignment with a corresponding optical fibre of the fibre optic plate.

10. The display device of claim 7, wherein the plurality of colour filters comprise a plurality of groups of colour filters, wherein a given group of colour filters is associated with sub-pixels of a given pixel and is arranged in alignment with a corresponding optical fibre of the fibre optic plate.

11. The display device of claim 7, wherein the plurality of colour filters are printed on the at least one of: the input surface, the output surface of the fibre optic plate.

12. The display device of claim 7, wherein the plurality of colour filters are formed according to a sub-pixel pattern of the display device.

13. The display device of claim 7, wherein the output surface of the fibre optic plate is curved.

14. A method of manufacturing an optical device, the method comprising forming a plurality of colour filters on at least one of: an input surface, an output of a fibre optic plate, the fibre optic plate comprising a plurality of optical fibres.

15. The method of claim 14, wherein a given colour filter is formed in alignment with a corresponding optical fibre of the fibre optic plate.

16. The method of claim 14, wherein the plurality of colour filters comprise a plurality of groups of colour filters, wherein a given group of colour filters is associated with sub-pixels of a given pixel and is formed in alignment with a corresponding optical fibre of the fibre optic plate.

17. The method of claim 14, further comprising forming a plurality of fiducial markers on the fibre optic plate, wherein the step of forming the plurality of colour filters is performed using the plurality of fiducial markers.

18. The method of claim 14, wherein the step of forming the plurality of colour filters comprises printing the plurality of colour filters on the at least one of: the input surface, the output surface of the fibre optic plate.

19. The method of claim 14, further comprising polishing the at least one of: the input surface, the output surface of the fibre optic plate prior to forming the plurality of colour filters.
